(19) United States
(12) Patent Application Publication
(10) Pub. No.: US 2026/0004355 A1
(43) Pub. Date: Jan. 1, 2026

(54) INVESTMENT ANALYSIS SYSTEM AND METHOD

(71) Applicant: Julien Baneux, Hawthorne, CA (US)

(72) Inventor: Julien Baneux, Hawthorne, CA (US)

(21) Appl. No.: 19/254,577

(22) Filed: Jun. 30, 2025

Related U.S. Application Data
(60) Provisional application No. 63/666,349, filed on Jul. 1, 2024.

(51) Int. Cl. G06Q 40/06

(52) U.S. Cl. CPC G06Q 40/06

(57) ABSTRACT

An investment analysis system and method enables the viewing and analysis of data, insights, graphics and metrics of any company. The investment analysis system and method further utilizes machine learning models to predict a probability of acquisition within a predetermined amount of time for each of the companies, based at least on historical acquisition data and company data, thereby assisting in investment decisions.

### CROSS-REFERENCE TO RELATED APPLICATION

The present application is related to and claims priority to U.S. Provisional Patent Application No. 63/666,349 filed Jul. 1, 2024, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of investment analysis of existing art and more specifically relates to a system and method to aid in investment decisions.

### RELATED ART

A Registered Investment Advisor (RIA) is a professional firm or individual who provides personalized financial advice and investment management services to clients and is registered with the Securities and Exchange Commission (SEC) or state securities authorities, depending on the size of the assets they manage.

Company acquisitions represent significant investment opportunities, as they can lead to increased market share, enhanced capabilities, and synergistic efficiencies for the acquiring firm. Investors and companies actively look for potential acquisition targets that align with their strategic goals, aiming to expand their reach, diversify their portfolios, or acquire innovative technologies. The process of identifying these opportunities typically involves a thorough analysis of financial statements, market conditions, competitive landscapes, and strategic fit. This due diligence ensures that the acquisition will be beneficial and align with the long-term goals of the acquiring company.

Currently, the task of predicting company acquisitions is primarily handled by human analysts who painstakingly compare financial metrics, industry trends, and company-specific factors. This manual approach is not only time-consuming but also prone to subjective biases and limitations in data processing capacity. Analysts must sift through vast amounts of data, making the process lengthy and resource-intensive.

Accordingly, a suitable solution is desired.

### SUMMARY OF THE INVENTION

In view of the foregoing disadvantages inherent in the investment analysis art, the present disclosure provides a novel investment analysis system and method. The general purpose of the present disclosure, which will be described subsequently in greater detail, is to provide a means for viewing and analyzing data, insights, graphics and metrics of any company for the Registered Investment Advisor (RIA) Industry. The present invention is superior to other systems in that it effectively consolidates company data into a searchable database and employs the use of artificial intelligence to predict company acquisition probability and ranks companies based on this probability to aid in investment decisions.

A method for investment analysis is disclosed herein. According to one or more embodiments of the present disclosure, the method for investment analysis may include retrieving, by at least one processor associated with at least one server, at least company data pertaining to a plurality of companies and data on historical company acquisitions from one or more external databases; training, by the at least one processor using a training algorithm, at least one machine learning model, using at least the historical acquisition data as training input; applying, by the at least one processor, the at least one machine learning model to the company data; validating, by the at least one processor, the at least one machine learning model based on at least one performance metric; determining, by the at least one processor using the at least one machine learning model, a likelihood of acquisition of each of the plurality of companies based on a comparison of the data on historical company acquisitions and the company data of each of the plurality of companies; assigning, by the at least one processor using the at least one machine learning model, an acquisition score to each of the plurality of companies; and displaying, by the at least one processor, upon request by a user, the acquisition score on a user interface accessed by the user and associated with the at least one server.

According to another embodiment, a system for investment analysis is also disclosed herein. The system for investment analysis may include at least one server including at least one processor and a memory, the memory storing company data pertaining to a plurality of companies and historical company acquisitions, retrieved from one or more external databases, and computer-executable instructions that, when executed by the at least one processor, cause the at least one processor to perform a method for investment analysis.

According to another embodiment, a method for investment analysis may include: retrieving, by at least one processor associated with at least one server, at least company data pertaining to a plurality of companies and data on historical company acquisitions from one or more external databases; training, by the at least one processor using a training algorithm, a plurality of machine learning models, using the historical acquisition data as training input; applying, by the at least one processor, the plurality of machine learning models on the company data; validating, by the at least one processor, the plurality of machine learning models based on at least one performance metric; selecting, by the at least one processor, a best performing machine learning model from the plurality of machine learning models, based on the at least one validation performance metric; determining, by the at least one processor using the best performing machine learning model, a likelihood of acquisition of each of the plurality of companies based on a comparison of the data on historical company acquisitions and the company data of each of the plurality of companies; assigning, by the at least one processor using the best performing machine learning model, an acquisition score to each of the plurality of companies; and displaying, by the at least one processor, upon request by a user, the acquisition score on a user interface accessed by the user and associated with the at least one server.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an investment analysis system and method, constructed and operative according to the teachings of the present disclosure.

FIG. 1 is a schematic diagram view of a system for investment analysis, according to an embodiment of the disclosure.

FIG. 2 is a flow diagram view of a method for investment analysis, according to an embodiment of the present disclosure.

FIG. 3 is another flow diagram view of the method for investment analysis, according to an embodiment of the present disclosure.

FIG. 4 is another flow diagram view of the method for investment analysis, according to an embodiment of the present disclosure.

FIG. 5 is a screenshot of an exemplary user interface of a database of the system for investment analysis, showing a firm overview page, according to an embodiment of the present disclosure.

FIG. 6 is another flow diagram view of the method for investment analysis, according to an embodiment of the present disclosure.

FIG. 7 is another flow diagram view of the method for investment analysis, according to an embodiment of the present disclosure.

FIG. 8 is a screenshot of an exemplary user interface of a database of the system for investment analysis, showing an acquisition score page, according to an embodiment of the present disclosure.

FIG. 9 is another screenshot of an exemplary user interface of a database of the system for investment analysis, showing the acquisition score page, according to an embodiment of the present disclosure.

FIG. 10 is another flow diagram view of the method for investment analysis, according to an embodiment of the present disclosure.

FIG. 11 is another flow diagram view of the method for investment analysis, according to an embodiment of the present disclosure.

FIG. 12 is another screenshot of an exemplary user interface of a database of the system for investment analysis, showing an advisors page having a propensity to leave score, according to an embodiment of the present disclosure.

FIG. 13 is another screenshot of an exemplary user interface of a database of the system for investment analysis, showing an advisors' page having the propensity to leave score, according to an embodiment of the present disclosure.

FIG. 14 is a screenshot of an exemplary user interface of a database of the system for investment analysis, showing an ADV brochure page, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to investment analysis and more particularly to an investment analysis and method, as used to improve the current means of organizing company data and making investment and acquisition analysis. The present invention provides a searchable database with graphics, enabling Registered Investment Advisors (RIA) to easily navigate the database, along with artificial intelligence to predict company acquisition probability, thereby informing investment decisions for RIA's and their clients.

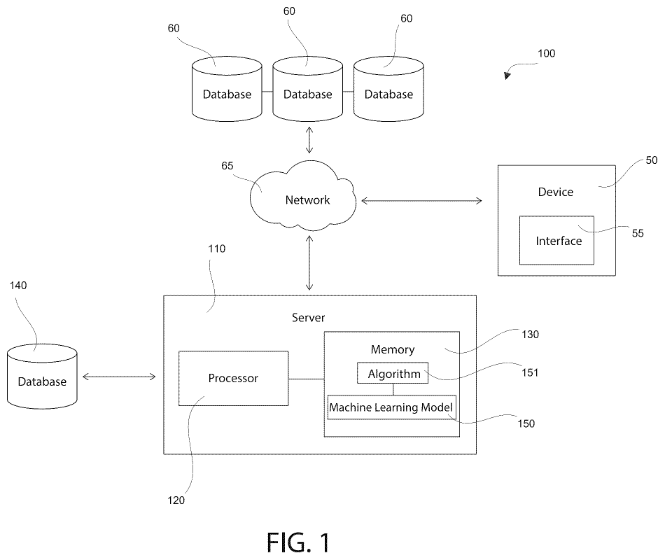

Referring now more specifically to the drawings by numerals of reference, there is shown in FIGS. 1-14, various views of a system for investment analysis 100 and method for investment analysis 200. Referring first to FIG. 1, there is shown a schematic diagram illustrating the system for investment analysis 100 according to one or more embodiments of the present disclosure. In particular, as shown here, the system for investment analysis 100 may include at least one server 110, at least one processor 120, a memory 130, a database 140 and one or more machine learning models 150. The memory 130 may store at least: company data pertaining to a plurality of companies and historical company acquisitions, retrieved from one or more external databases 60; and computer-executable instructions that, when executed by the at least one processor 120, cause the at least one processor 120 to perform the method for investment analysis 200, which will be discussed in more detail below.

In some examples, the at least one server 110 may include any suitable type of computing environment capable of storing, processing, and delivering data and instructions. This may include a physical on-premise server, such as a dedicated hardware system located within a data center or facility, a cloud-based server hosted by a third-party provider, and/or a hybrid server environment that combines aspects of both on-premise and cloud infrastructure. The at least one server 110 may operate as part of a distributed or virtualized computing environment. In certain embodiments, the at least one server 110 may be configured to dynamically scale resources, manage data replication, or interface with client devices through APIs or web-based platforms.

In some examples, one or more processors 120 may be provided on the server 110 or a client device 50. The processor(s) 120 may include any suitable type of data processing unit, such as a central processing unit (CPU), graphics processing unit (GPU), digital signal processor (DSP), or other specialized or general-purpose processor. The processor(s) 120 may manage data communication between components such as the memory 130, database(s) 140, machine learning models 150, and user interfaces 55. The processor(s) 120 may be configured to execute local applications, render user interfaces, and communicate with the server 110 via a network connection 65.

In some examples, the memory 130 may include one or more memory components operatively connected to the processor 120, such as volatile memory (e.g., RAM) and/or non-volatile memory (e.g., flash storage, solid-state drives, or hard disk drives). The memory 130 may store data, executable instructions, machine learning models, user preferences, system configurations, or any other information necessary for server operation. In some embodiments, the memory 130 may also temporarily cache input data and store intermediate results during processing or model evaluation.

In some examples, the system for investment analysis 100 may employ one or more machine learning models 150 that are trained to generate predictions, classifications, scores, or other outputs based on input data. These models may include, without limitation, regression models, decision trees, ensemble methods (e.g., random forests, gradient boosting), neural networks, or transformer-based architectures. A machine learning algorithm 151 may be used to train or update the model 150 based on labeled or unlabeled training data. The machine learning algorithm 151 may include optimization techniques such as stochastic gradient descent, backpropagation, or boosting techniques, depending on the model architecture. The trained model 150 may be stored in memory 130 and accessed by the processor 120 to generate outputs.

In some examples, the system for investment analysis 100 may include or be in communication with one or more databases 150 configured to store structured or unstructured information, such as company profiles, training data, user information, transaction logs, model outputs, etc. The database 150 may reside locally on the server 110 or may be accessible via one or more remote database servers or cloud storage services. In certain embodiments, the processor 120 may be configured to retrieve, update, or query data from the database 150. The database 150 may also support indexing, filtering, and search operations to facilitate efficient data retrieval.

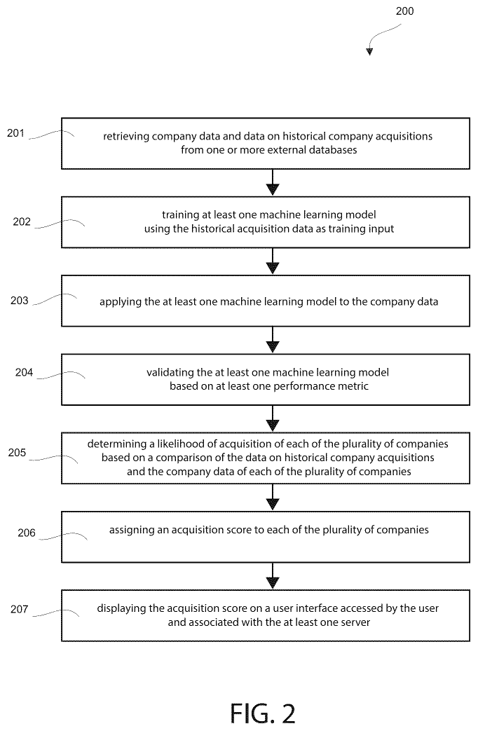

Referring now also to FIGS. 2-4, which show flow diagrams illustrating a method for investment analysis 200, according to one or more embodiments of the present disclosure. Beginning first with FIG. 2, as shown here, the method for investment analysis 200 may include step 201, retrieving, by at least one processor 120 associated with at least one server 110, at least company data pertaining to a plurality of companies and data on historical company acquisitions from one or more external databases 60; step 202, training, by the at least one processor 120 using a training algorithm 151, at least one machine learning model 150, using at least the historical acquisition data as training input; step 203, applying, by the at least one processor 120, the at least one machine learning model 150 to the company data; step 204, validating, by the at least one processor 120, the at least one machine learning model 150 based on at least one performance metric; step 205, determining, by the at least one processor 120 using the at least one machine learning model 150, a likelihood of acquisition of each of the plurality of companies based on a comparison of the data on historical company acquisitions and the company data of each of the plurality of companies; step 206, assigning, by the at least one processor 120 using the at least one machine learning model 150, an acquisition score 141 to each of the plurality of companies; and step 207, displaying, by the at least one processor 120, upon request by a user, the acquisition score 141 on a user interface 55 accessed by the user (on a client device 50 such as a computer, a smartphone, etc.), and associated with the at least one server 110.

In some embodiments, step 205 includes determining a likelihood of acquisition within a predetermined time period. For example, 1 month to 9 months. However, it should be appreciated that this time period is only given as an example. Other time periods may be utilized, such as 6 months to 12 months, 0.5 months to 9 months, etc.

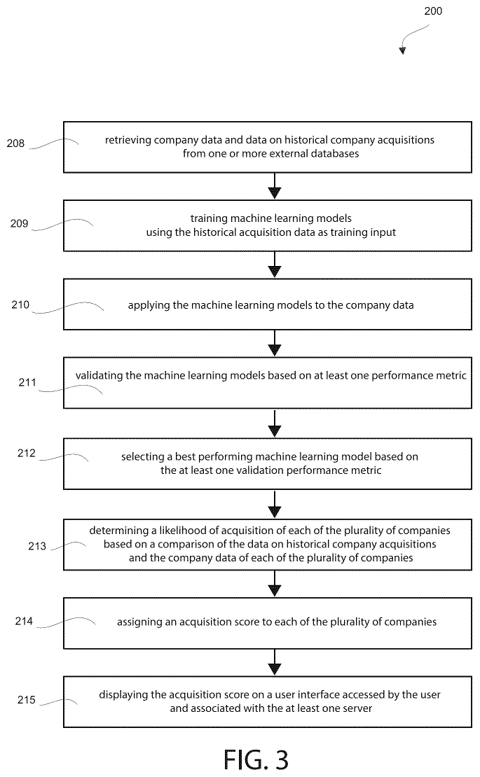

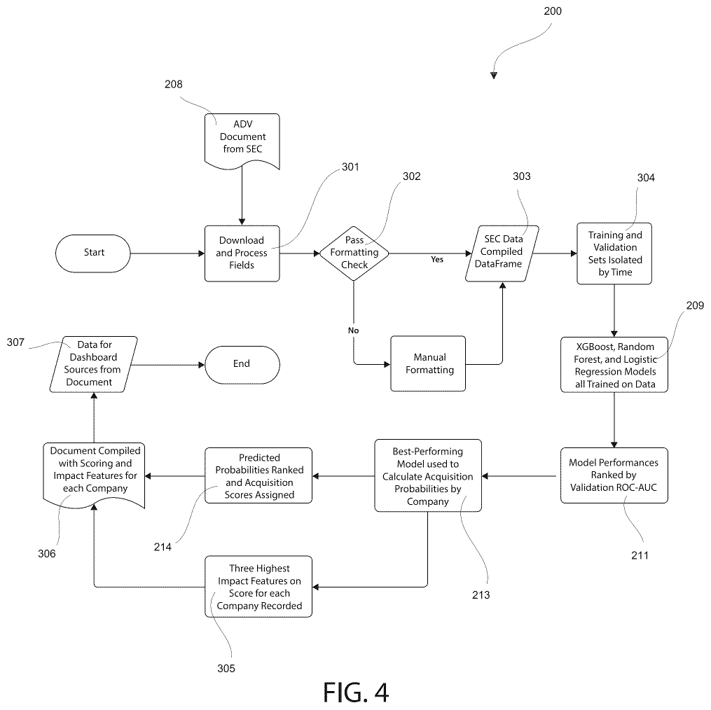

As demonstrated in FIGS. 3-4, the method for investment analysis 200 may include step 208, retrieving, by at least one processor 120 associated with at least one server 110, at least company data pertaining to a plurality of companies and data on historical company acquisitions from one or more external databases 60; step 209 training, by the at least one processor 120 using a training algorithm 151, a plurality of machine learning models 150, using the historical acquisition data as training input; step 210, applying, by the at least one processor 120, the plurality of machine learning models 150 on the company data; step 211, validating, by the at least one processor 120, the plurality of machine learning models 150 based on at least one performance metric; step 212, selecting, by the at least one processor 120, a best performing machine learning model 150 from the plurality of machine learning models 150, based on the at least one validation performance metric; step 213, determining, by the at least one processor 120 using the best performing machine learning model 150, a likelihood of acquisition of each of the plurality of companies based on a comparison of the data on historical company acquisitions and the company data of each of the plurality of companies; step 214, assigning, by the at least one processor 120 using the best performing machine learning model 150, an acquisition score 141 to each of the plurality of companies; and step 215, displaying, by the at least one processor 120, upon request by a user, the acquisition score 141 on a user interface 55 accessed by the user and associated with the at least one server 110. As above, in some embodiments, step 213 includes determining a likelihood of acquisition within a predetermined time period.

As demonstrated in FIG. 4, additional steps may include processing fields 301, running formatting checks 302 (and manually formatting if it does not pass), compiling the data into a DataFrame 303, isolating training and validation sets by time 304, recording highest impact features on acquisition score 305, compiling documents with scoring and impact features for each company 306, and using the document for populating a dashboard 307.

The plurality of machine learning models 150 may include XGBoost models, Random Forest models, Logistic Regression models, Large Language Models, and any combination thereof. Further, the least one performance metric may include Receiver Operating Characteristic Area Under the Curve (ROC-AUC). The training algorithm 151 and the machine learning models 150 may be saved on the memory 130 of the at least one server 110.

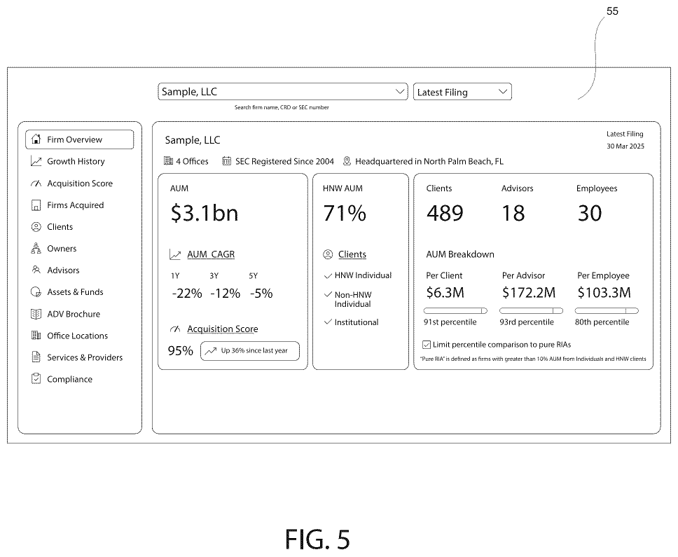

Referring now also to FIG. 5, there is shown an exemplary screenshot of a user interface 55 accessing the database 140 of the system for investment analysis 100, according to one or more embodiments of the present disclosure. As shown here and as discussed above, the system for investment analysis may provide a searchable database 140, enabling RIA's to easily navigate the database 140 to analyze and view information regarding any company. It is contemplated that the system for investment analysis provides the user with information needed to investigate a company and view all data needed to make an acquisition or merger decision.

For example, the searchable database 140 can include firm overview (as shown here in FIG. 5), which can include (but is not limited to) Assets Under Management (AUM), AUM Compound Annual Growth Rate (AUM CAGR) and AUM breakdown by clients, advisors and employees; growth history, acquisition score, firms acquired, clients, owners, advisors, assets and funds, ADV brochure, office locations, services and providers and compliance. It should be appreciated however that this list is not exhaustive; nor is the database 140 limited to including all of the fields listed here.

In some embodiments, the database 140 (via the user interface 55) may enable a user to narrow their search to certain characteristics. For example, if the user would like to view all companies with up to 20 employees, they can utilize the user interface to narrow the search down to companies with up to 20 employees which then provides a list, or table, to the user. The user can then go through the list and utilize the tabs to view data regarding those particular companies.

The retrieval of data step (201 or 208), as above, may retrieve at least company data pertaining to a plurality of companies and data on historical company acquisitions from one or more external databases 60. The company data may include (but is not limited to) AUM, AUM from high net worth (HNW) individuals, AUM from non-HNW individuals, number of HNW clients, number of employees, number of employees performing advisory functions, asset allocation variables, whether a firm has a history of compliance problems, whether a firm has any external owners, number of owners a firm has, etc. This data may be retrieved from a database, or website, of the U.S. Securities and Exchange Commission (SEC) and may be retrieved on a monthly basis.

Data on historical company acquisitions may include information such as (but not limited to) name of acquired firm, name of acquiring firm, date of acquisition, AUM of acquired firm at time of acquisition, whether the acquisition was a minority stake or a full acquisition, location of acquired firm, etc. This data may be retrieved from databases/websites such as FIDELITY® and news sources and may be retrieved on a monthly basis.

Other data retrieved from the one or more external databases 60 may include advisor data, which will be discussed in more detail below. The advisor data may include information such as (but not limited to) age, years of experience, former firms, location, name (for guessing gender), average tenure at former firms, whether the advisor has been fired, whether the advisor has a customer complaint, whether the advisor has been charged with a crime, whether the advisor is going through a divorce (according to public records), etc. This data may be retrieved from the SEC website/database, the SEC Investment Adviser Public Disclosure (IAPD) database, and/or websites/databases such as WEALTHFEED® and may be retrieved on a daily basis.

The at least one processor 120 may be configured to retrieve the above data (company data, historical acquisition data, advisor data—collectively ‘variables data’) from six different sources: ADV Part 1 Forms from SEC IAPD, ADV Part 2 Brochures from SEC IAPD, Advisor Information from SEC IAPD, Registered Investment Advisor Information from SEC, Data on Ages from WEALTHFEED® and Data on Acquisitions from FIDELITY® and other news sources.

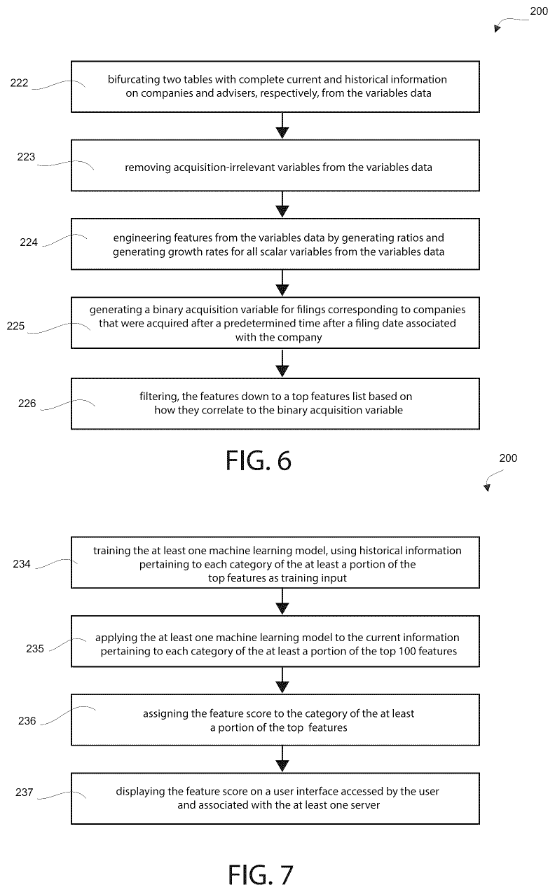

Pre-processing steps may be performed on the variables data prior to teaching the at least one machine learning model 150. In particular, as demonstrated in FIG. 6, the pre-processing steps may include: step 222, bifurcating, by the at least one processor 120, two tables with complete current and historical information on companies and advisors, respectively, from the variables data; step 223, removing, by the at least one processor 120, acquisition-irrelevant variables from the variables data (e.g., email addresses, websites, other business names, etc.); step 224, engineering, by the at least one processor 120, features from the variables data by generating ratios (e.g., AUM/client, AUM/offices, clients/advisors, etc.) and generating growth rates for all scalar variables from the variables data (including ratios), for one, two, and three years; step 225, generating, by the at least one processor 120, a binary acquisition variable for filings corresponding to companies that were acquired after a predetermined time after a filing date associated with the company; and step 226, filtering, by the at least one processor 120, the features down to a top feature list (e.g., top 100) based on how they correlate to the binary acquisition variable.

In some embodiments, as shown in FIG. 7, the method for investment analysis 200 may further comprise the step of assigning a feature score per category of at least a portion of the top feature list. In particular, the method for investment analysis may comprise: step 234, training, by the at least one processor 120 using a training algorithm 151, the at least one machine learning model 150, using at least historical information pertaining to each category of the at least a portion of the top feature list as training input; step 235, applying, by the at least one processor 120, the at least one machine learning model 150 to the current information pertaining to each category of the at least a portion of the top feature list; step 236, assigning, by the at least one processor 120 using the at least one machine learning model 150, the feature score to the category of the at least a portion of the top feature list; and step 237, displaying, by the at least one processor 120, upon request by the user, the feature score on the user interface 55 accessed by the user and associated with the at least one server 110.

For example, scores by feature may include: AUM/efficiency score (which may be out of 100); ownership structure score (which may be out of 10); asset allocation score (which may be out of 10) and compliance score (which may be out of 10). It should be appreciated that this list is not exhaustive. Further, feature scores may change based on user inputs on forms/questionnaires via the user interface 55 (which can be through the database 140, through a mobile application, etc.).

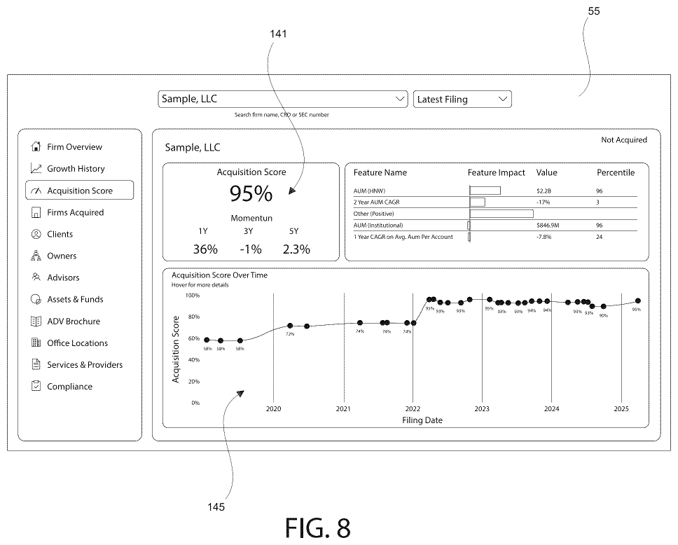

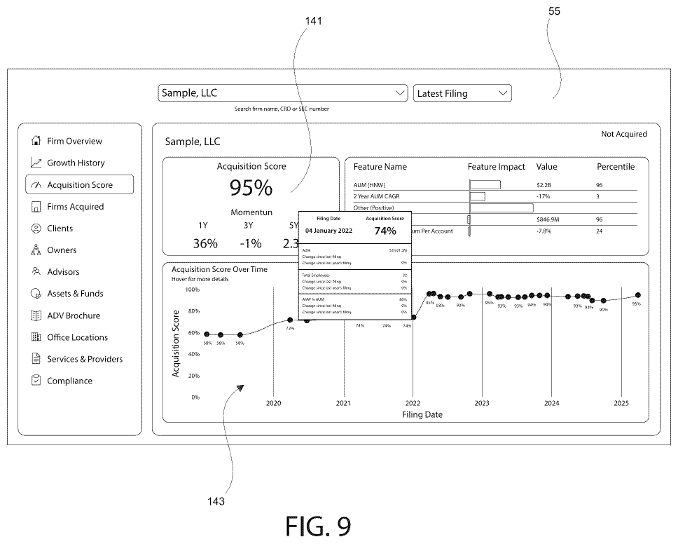

As shown in the screenshots of FIGS. 8-9, and as discussed in steps 207 and 215, the at least one processor 120 is configured to display the acquisition score 141 to the user via the user interface 55. As shown here, the acquisition score 141 may be shown as a percentage on the database 140. For example, as shown here, the acquisition score 141 may be 95%—meaning that there is a 95% likelihood of acquisition. Again, this may be over a certain time period, such as, but not limited to, 1-9 months. Further, in some embodiments, the acquisition score 141 may be displayed in a particular color reflecting the score. For example, scores between 0-50 may be shown in red; scores between 51-70 may be shown in yellow; and scores above 70 may be shown in green.

It is contemplated that the company data may be stored within the database 140 associated with the at least one server 110. The database 140 may include a plurality of company profiles each corresponding to a respective one of the plurality of companies. The company data is organized within each respective company profile, and the acquisition score 141 associated with each of the plurality of companies is stored within the corresponding company profile.

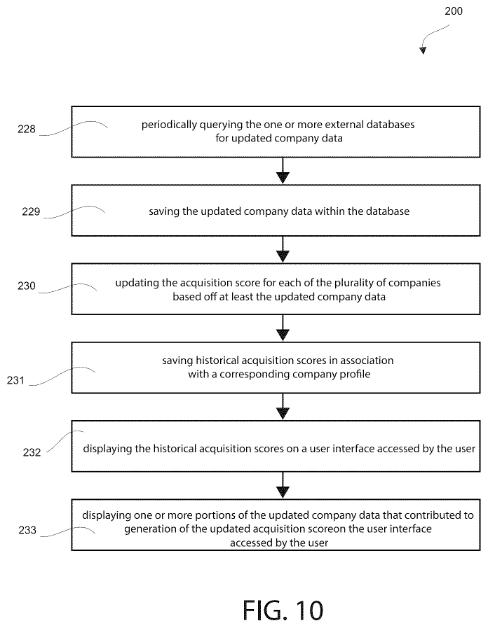

Referring now also to the flow diagram of FIG. 10, illustrating further steps of the method for investment analysis 200. As shown here, further steps may include: step 228, periodically querying (e.g., on a monthly basis), by the at least one processor 120, the one or more external databases 60 for updated company data; step 229, saving, by the at least one processor 120, the updated company data within the database 140 of the memory 130; step 230, updating, by the at least one processor 120 using the at least one machine learning model 150, the acquisition score 141 for each of the plurality of companies based off at least the updated company data; step 231, saving, by the at least one processor 120, historical acquisition scores 145 in association with a corresponding company profile; step 232, displaying, by the at least one processor 120 upon request by a user, the historical acquisition scores 145 on a user interface 55 accessed by the user; and step 233, displaying, by the at least one processor 120 upon request by the user, one or more portions of the updated company data that contributed to generation of the updated acquisition score 141, on the user interface 55 accessed by the user.

In some embodiments, as shown in FIG. 8-9, the historical acquisition scores 145 may be shown as a graph. As shown in FIG. 9, once clicking on a plot on the graph, one or more portions of the updated company data that contributed to generation of the updated acquisition score 141 is then displayed. For example, as shown here, this may include AUM, total employees and HNW % AUM.

In some embodiments, the companies may be ranked within the database 140 on their acquisition scores 141. Further, the features, or criteria points, having the highest impact on the score for each company may be recorded and saved in the memory 130 and/or database 140. For example, five of the highest impact features can be recorded. In particular, the machine learning models 150 are able to utilize the historical acquisition data and identify key criteria points on an industry basis as well as a firm-by-firm acquirer basis that are present in the historical acquisition data. For example, as shown in FIG. 9, this may include: AUM (HNW), 2 year AUM CAGR, Other (Positive), AUM (Institutional) and 1 Year CAGR on Avg. AUM Per account.

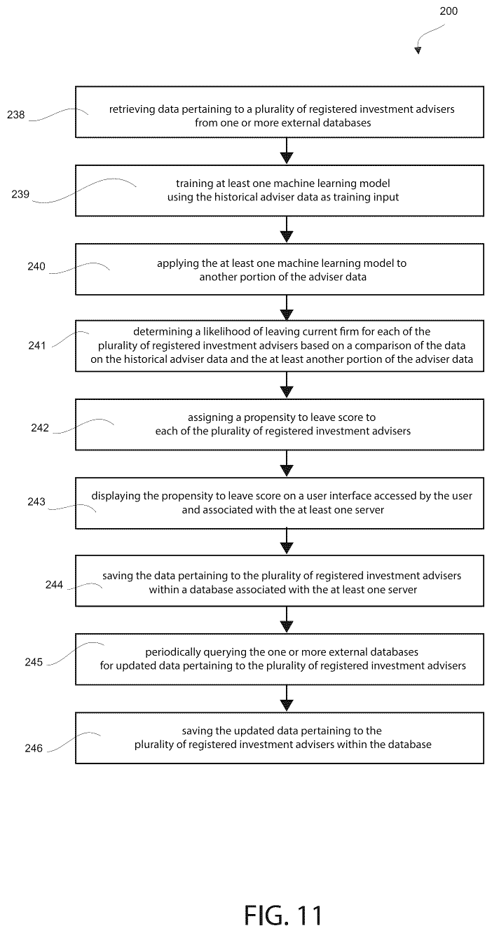

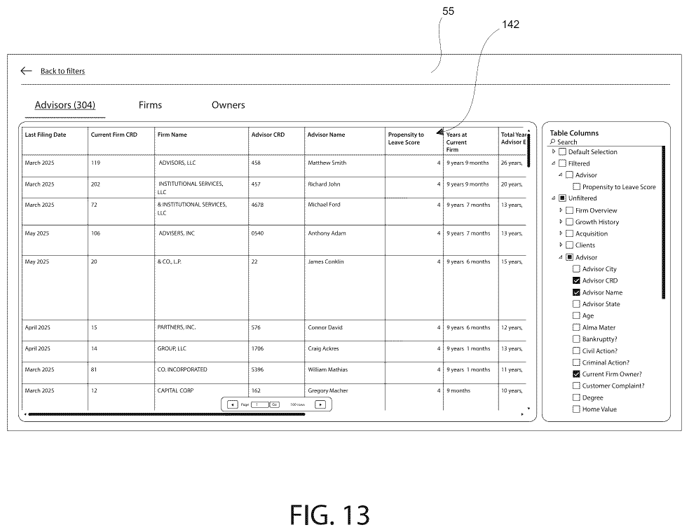

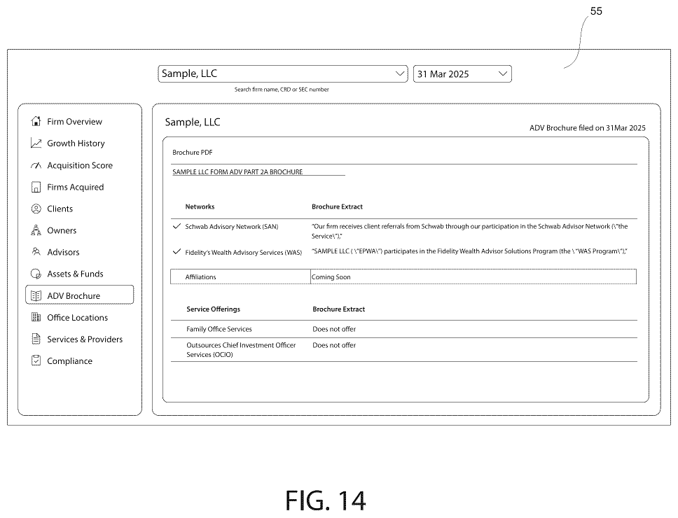

Referring now to FIGS. 11-14, there is shown a flow diagram illustrating further steps of the method for investment analysis 200 (FIG. 11) and additional screenshots of the database 140 of the system for investment analysis 100 (FIGS. 13-14). Beginning first with FIG. 11, the steps may include: step 238, retrieving, by at least one processor 120, adviser data pertaining to a plurality of registered investment advisers from one or more external databases 60, a portion of the adviser data including historical adviser data; step 239, training, by the at least one processor 120 using a training algorithm 151, at least one machine learning model 150, using the historical adviser data as training input; step 240, applying, by the at least one processor 120, the at least one machine learning model 150 to at least another portion of the adviser data; step 241, determining, by the at least one processor 120 using the at least one machine learning model 150, a likelihood of leaving current firm for each of the plurality of registered investment advisers based on a comparison of the data on the historical adviser data and the at least another portion of the adviser data of the plurality of registered investment advisers; step 242, assigning, by the at least one processor 120 using the at least one machine learning model 150, a propensity to leave score 142 to each of the plurality of registered investment advisers; step 243, displaying, by the at least one processor 120, upon request by a user, the propensity to leave score 142 on a user interface 55 accessed by the user and associated with the at least one server 110; step 244, saving, by the at least one processor 120, the data pertaining to the plurality of registered investment advisers within the memory 130 and/or database 140 associated with the at least one server 110; step 245, periodically querying (e.g., on a daily basis) the one or more external databases 60 for updated data pertaining to the plurality of registered investment advisers; and step 246, saving the updated data pertaining to the plurality of registered investment advisers within the memory 130 and/or database 140.

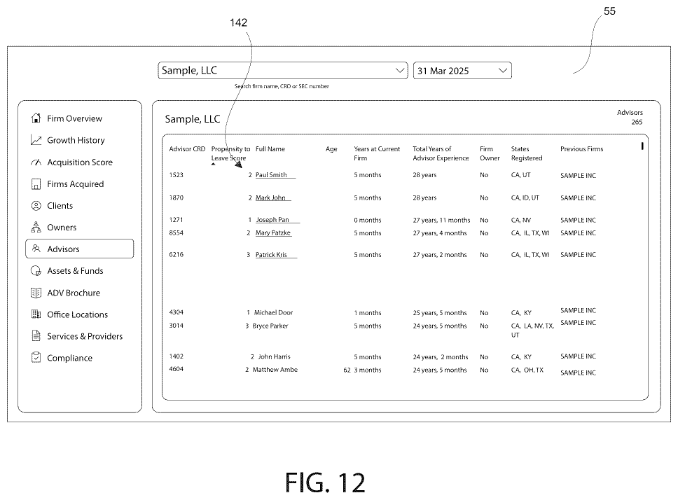

As discussed above, the advisor data may include information such as (but not limited to) age, years of experience, former firms, location, name (for guessing gender), average tenure at former firms, whether the advisor has been fired, whether the advisor has a customer complaint, whether the advisor has been charged with a crime, whether the advisor is going through a divorce (according to public records), etc. This data may be retrieved from the SEC website/database, the SEC Investment Adviser Public Disclosure (IAPD) database, and/or websites/databases such as WEALTHFEED® and may be retrieved on a daily basis. The data may be retrieved from ADV Part 1 Forms from SEC IAPD, ADV Part 2 Brochures from SEC IAPD, Advisor Information from SEC IAPD, Registered Investment Advisor Information from SEC, and Data on Ages from WEALTHFEED®. As shown in FIGS. 12-13, the propensity to leave score 142 may be from 1-5, with 5 being a high likelihood of leaving; and 1 being a low likelihood of leaving.

Referring now to FIG. 14, which shows an exemplary screenshot of the user interface 55 (providing access to the database 140), showing an “ADV brochure” page. Here, the at least one processor 120 may retrieve the ADV Part 2 Brochures from SEC IAPD, extract predetermined data from each of the ADV brochures (using one or more machine learning models-such as large language models) and save the predetermined data, along with the ADV brochures, within the database 140. As such, as shown in FIG. 14, the user is able to quickly and easily view pertinent information from the ADV brochure.

It should be noted that certain steps are optional and may not be implemented in all cases. It should also be noted that the steps described in the method of use can be carried out in many different orders. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for investment analysis, the method comprising the steps of:
retrieving, by at least one processor associated with at least one server, at least company data pertaining to a plurality of companies and data on historical company acquisitions from one or more external databases;
training, by the at least one processor using a training algorithm, at least one machine learning model, using at least the historical acquisition data as training input;
applying, by the at least one processor, the at least one machine learning model to the company data;
validating, by the at least one processor, the at least one machine learning model based on at least one performance metric;
determining, by the at least one processor using the at least one machine learning model, a likelihood of acquisition of each of the plurality of companies based on a comparison of the data on historical company acquisitions and the company data of each of the plurality of companies;
assigning, by the at least one processor using the at least one machine learning model, an acquisition score to each of the plurality of companies; and
displaying, by the at least one processor, upon request by a user, the acquisition score on a user interface accessed by the user and associated with the at least one server.

2. The method of claim 1, wherein the step of determining a likelihood of acquisition includes determining a likelihood of acquisition within a predetermined time period.

3. The method of claim 1, wherein the at least one machine learning model includes a plurality of machine learning models, wherein the method further comprises the steps of:
selecting, by the at least one processor, a best performing machine learning model from the plurality of machine learning models, based on the at least one performance metric; and
wherein both the determining the likelihood of acquisition step and the assigning the acquisition score step are performed using the best performing machine learning model from the plurality of machine learning models.

4. The method of claim 3, wherein the plurality of machine learning models includes XGBoost models, Random Forest models, Logistic Regression models, Large Language Models, and any combination thereof.

5. The method of claim 1, wherein the at least one performance metric includes ROC-AUC.

6. The method of claim 1, wherein the step of retrieving at least company data pertaining to a plurality of companies and data on historical company acquisitions from one or more external databases comprises the retrieval of variables data from ADV Part 1 Forms, ADV Part 2 Brochures, Advisor Information, Registered Investment Advisor Information, Data on Ages and Data on Acquisitions;
wherein pre-processing steps are performed prior to teaching the at least one machine learning model; and
wherein the pre-processing steps comprise:
bifurcating, by the at least one processor, two tables with complete current and historical information on companies and advisers, respectively, from the variables data;
removing, by the at least one processor, acquisition-irrelevant variables from the variables data;
engineering, by the at least one processor, features from the variables data by:
generating ratios; and
generating growth rates for all scalar variables from the variables data;
generating, by the at least one processor, a binary acquisition variable for filings corresponding to companies that were acquired after a predetermined time after a filing date associated with the company; and
filtering, by the at least one processor, the features down to a top feature list based on how they correlate to the binary acquisition variable.

7. The method of claim 6, wherein the method further comprises assigning a feature score per category of at least a portion of the top feature list, the feature score generated by at least:
training, by the at least one processor using a training algorithm, the at least one machine learning model, using at least historical information pertaining to each category of the at least a portion of the top feature list as training input;
applying, by the at least one processor, the at least one machine learning model to the current information pertaining to each category of the at least a portion of the top feature list;
assigning, by the at least one processor using the at least one machine learning model, the feature score to the category of the at least a portion of the top feature list; and
displaying, by the at least one processor, upon request by a user, the feature score on a user interface accessed by the user and associated with the at least one server.

8. The method of claim 1, wherein the method further comprises:
storing, by the at least one processor, the company data within a database associated with the at least one server; and
wherein the database is accessible and searchable via the user interface, wherein the database comprises a plurality of company profiles each corresponding to a respective one of the plurality of companies, wherein the company data is organized within each respective company profile, and wherein the acquisition score associated with each of the plurality of companies is stored within the corresponding company profile.

9. The method of claim 1, further comprising the steps of:
periodically querying, by the at least one processor, the one or more external databases for updated company data;
saving, by the at least one processor, the updated company data within the database; and
updating, by the at least one processor using the at least one machine learning model, the acquisition score for each of the plurality of companies based off at least the updated company data.

10. The method of claim 9, further comprising the steps of:
saving, by the at least one processor, historical acquisition scores in association with a corresponding company profile;
displaying, by the at least one processor upon request by a user, the historical acquisition scores on a user interface accessed by the user;
displaying, by the at least one processor upon request by the user, one or more portions of the updated company data that contributed to generation of the updated acquisition score, on the user interface accessed by the user.

11. The method of claim 1, further comprising the steps of:
retrieving, by at least one processor, adviser data pertaining to a plurality of registered investment advisers from one or more external databases, a portion of the adviser data including historical adviser data;
training, by the at least one processor using a training algorithm, at least one machine learning model, using the historical adviser data as training input;
applying, by the at least one processor, the at least one machine learning model to at least another portion of the adviser data;
determining, by the at least one processor using the at least one machine learning model, a likelihood of leaving current firm for each of the plurality of registered investment advisers based on a comparison of the data on the historical adviser data and the at least another portion of the adviser data of the plurality of registered investment advisers;
assigning, by the at least one processor using the at least one machine learning model, a propensity to leave score to each of the plurality of registered investment advisers; and
displaying, by the at least one processor, upon request by a user, the propensity to leave score on a user interface accessed by the user and associated with the at least one server;

12. The method of claim 11, further comprising the steps of:
saving, by the at least one processor, the data pertaining to the plurality of registered investment advisers within a database associated with the at least one server;
periodically querying, by the at least one processor, the one or more external databases for updated data pertaining to the plurality of registered investment advisers; and
saving, by the at least one processor, the updated data pertaining to the plurality of registered investment advisers within the database.

13. The method of claim 12, wherein the data pertaining to the plurality of registered investment advisers includes a plurality of ADV brochures, and wherein the method further comprises:
retrieving, by the at least one processor, predetermined data from each of the plurality of ADV brochures; and
saving, by the at least one processor, at least the predetermined data within the database associated with the at least one server;
the database being accessible and searchable via the user interface, the database including a plurality of registered investment advisers' profiles each pertaining to one of the plurality of registered investment advisers, and wherein the appropriate predetermined data is organized accordingly within the respective registered investment advisers' profiles.

14. A system for investment analysis, comprising:
at least one server including at least one processor and a memory, the memory storing company data pertaining to a plurality of companies and historical company acquisitions, retrieved from one or more external databases, and computer-executable instructions that, when executed by the at least one processor, cause the at least one processor to:
train at least one machine learning model using the historical acquisition data as training input;
apply the machine learning model to the company data;
validate the at least one machine learning model based on at least one performance metric;
determine, using the at least one machine learning model, a likelihood of acquisition of each of the plurality of companies based on a comparison of the data on historical company acquisitions and the company data of each of the plurality of companies;
assign, using the at least one machine learning model, an acquisition score to each of the plurality of companies; and
display, upon request by a user, the acquisition score on a user interface accessed by the user and associated with the at least one server.

15. The system of claim 14, wherein the at least one processor is further configured to determine a likelihood of acquisition within a predetermined time period.

16. The system of claim 14, wherein the at least one machine learning model includes a plurality of machine learning models, wherein the at least one processor is further configured to select a best performing machine learning model from the plurality of machine learning models, based on the at least one performance metric, and wherein both the determining the likelihood of acquisition step and the assigning the acquisition score step are performed using the best performing machine learning model from the plurality of machine learning models.

17. The system of claim 16, wherein the plurality of machine learning models includes XGBoost models, Random Forest models, Logistic Regression models, Large Language Models, and any combination thereof.

18. The system of claim 14, wherein the at least one performance metric includes ROC-AUC.

19. The system of claim 14, wherein the step of retrieving at least company data pertaining to a plurality of companies and data on historical company acquisitions from one or more external databases comprises the retrieval of variables data from ADV Part 1 Forms, ADV Part 2 Brochures, Advisor Information, Registered Investment Advisor Information, Data on Ages and Data On Acquisitions;
wherein the at least one processor is configured to perform pre-processing steps prior to teaching the at least one machine learning model; and
wherein the pre-processing steps comprise:
bifurcating two tables with complete current and historical information on companies and advisers, respectively, from the variables data;
removing acquisition-irrelevant variables from the variables data;
engineering features from the variables data by:
generating ratios; and
generating growth rates for all scalar variables from the variables data;
generating a binary acquisition variable for filings corresponding to companies that were acquired after a predetermined time after a filing date associated with the company; and
filtering the features down to a top feature list based on how they correlate to the binary acquisition variable.

20. The system of claim 19, wherein the at least one processor is further configured to assign a feature score per category of at least a portion of the top feature list, by at least:
training, using a training algorithm, the at least one machine learning model, using at least historical information pertaining to each category of the at least a portion of the top feature list as training input;
applying the at least one machine learning model to the current information pertaining to each category of the at least a portion of the top feature list;
assigning, using the at least one machine learning model, the feature score to the category of the at least a portion of the top feature list; and
displaying, upon request by a user, the feature score on a user interface accessed by the user and associated with the at least one server.

21. The system of claim 14, wherein the at least one processor is further configured to store the company data within a database associated with the at least one server, wherein the database is accessible and searchable via the user interface, wherein the database comprises a plurality of company profiles each corresponding to a respective one of the plurality of companies, wherein the company data is organized within each respective company profile, and wherein the acquisition score associated with each of the plurality of companies is stored within the corresponding company profile.

22. The system of claim 14, wherein the at least one processor is further configured to periodically query the one or more external databases for updated company data; save the updated company data within the database; and update, using the at least one machine learning model, the acquisition score for each of the plurality of companies based off at least the updated company data.

23. The system of claim 22, wherein the at least one processor is further configured to save historical acquisition scores in association with a corresponding company profile, display, upon request by a user, the historical acquisition scores on a user interface accessed by the user, and further display, upon request by the user, one or more portions of the updated company data that contributed to generation of the updated acquisition score, on the user interface accessed by the user.

24. The system of claim 14, wherein the at least one processor is further configured to:
retrieve adviser data pertaining to a plurality of registered investment advisers from one or more external databases, a portion of the adviser data including historical adviser data;
train, using a training algorithm, at least one machine learning model, using the historical adviser data as training input;
apply the at least one machine learning model to at least another portion of the adviser data;
determine, using the at least one machine learning model, a likelihood of leaving current firm for each of the plurality of registered investment advisers based on a comparison of the data on the historical adviser data and the at least another portion of the adviser data of the plurality of registered investment advisers;
assign, using the at least one machine learning model, a propensity to leave score to each of the plurality of registered investment advisers; and
display, upon request by a user, the propensity to leave score on a user interface accessed by the user and associated with the at least one server;

25. The system of claim 24, wherein the at least one processor is further configured to:
save the data pertaining to the plurality of registered investment advisers within a database associated with the at least one server;
periodically query the one or more external databases for updated data pertaining to the plurality of registered investment advisers; and
save the updated data pertaining to the plurality of registered investment advisers within the database.

26. The system of claim 25, wherein the data pertaining to the plurality of registered investment advisers includes a plurality of ADV brochures, and wherein at least one processor is further configured to:
retrieve predetermined data from each of the plurality of ADV brochures; and
save at least the predetermined data within a database associated with the at least one server; and
wherein the database is accessible and searchable via the user interface, wherein the database includes a plurality of registered investment advisers' profiles each pertaining to one of the plurality of registered investment advisers, and wherein the appropriate predetermined data is organized accordingly within the respective registered investment advisers' profiles.

27. A method for investment analysis, comprising:
retrieving, by at least one processor associated with at least one server, at least company data pertaining to a plurality of companies and data on historical company acquisitions from one or more external databases;
training, by the at least one processor using a training algorithm, a plurality of machine learning models, using the historical acquisition data as training input;
applying, by the at least one processor, the plurality of machine learning models to the company data;
validating, by the at least one processor, the plurality of machine learning models based on at least one performance metric;
selecting, by the at least one processor, a best performing machine learning model from the plurality of machine learning models, based on the at least one validation performance metric;
determining, by the at least one processor using the best performing machine learning model, a likelihood of acquisition of each of the plurality of companies based on a comparison of the data on historical company acquisitions and the company data of each of the plurality of companies;
assigning, by the at least one processor using the best performing machine learning model, an acquisition score to each of the plurality of companies; and
displaying, by the at least one processor, upon request by a user, the acquisition score on a user interface accessed by the user and associated with the at least one server.

28. The method of claim 27, wherein the plurality of machine learning models includes XGBoost models, Random Forest models, Logistic Regression models, Large Language Models, and any combination thereof.

29. The method of claim 27, wherein the at least one performance metric includes ROC-AUC.
